(19) United States
(12) Patent Application Publication
(10) Pub. No.: US 2012/0291810 A1
(43) Pub. Date: Nov. 22, 2012

(54) CLEANING SYSTEMS AND CONTROL METHODS THEREOF

(76) Inventors: Shui-Shih CHEN, Changhua (TW); You-Wei Teng, New Taipei (TW)

(21) Appl. No.: 13/419,682

(22) Filed: Mar. 14, 2012

(30) Foreign Application Priority Data
May 17, 2011 (TW) 100117153

(51) Int. Cl. A47L 11/00; A47L 11/40; B08B 7/04

(52) U.S. Cl. 134/18; 15/3

(57) ABSTRACT

A cleaning system is provided. The cleaning system includes at least one sign object and a cleaning robot. The cleaning robot detects and records a position of the sign object to generate a recorded result. The cleaning robot has a locking function. When the locking function has been activated, the cleaning robot performs a cleaning operation according to the recorded result. When the locking function has been activated and the sign object has been removed, the cleaning robot is capable of performing the cleaning operation according to the position of the sign object before it was removed.

### CROSS REFERENCE TO RELATED APPLICATIONS

This Application claims priority of Taiwan Patent Application No. 100117153, filed on May 17, 2011, the entirety of which is incorporated by reference herein.

### BACKGROUND OF THE INVENTION

1. Field of the Invention

The invention relates to a cleaning system, and more particularly to a cleaning system comprising a cleaning robot.

2. Description of the Related Art

With technological advancements, the number of the types of electronic products, including cleaning robots, has increased. Generally, a sign object is used to limit a cleaning area of a cleaning robot. When a cleaning robot performs a cleaning operation, if the cleaning robot detects the existence of a sign object, the cleaning robot avoids the area of the sign object.

Thus, before a cleaning robot performs a cleaning operation, a user has to place sign objects. If a user forgets to place a sign object, the cleaning robot may enter dangerous areas, for example, an outdoor area. Moreover, in order to achieve preferred cleaning effect, several sign objects are usually required to reduce the cleaning area of the cleaning robot. However, a large number of sign objects increases cost and also affects decoration and appearance of the interior of a house disadvantageously.

### BRIEF SUMMARY OF THE INVENTION

An exemplary embodiment of a cleaning system comprises at least one sign object and a cleaning robot. The cleaning robot detects and records a position of the sign object to generate a recorded result. The cleaning robot has a locking function. When the locking function has been activated, the cleaning robot performs a cleaning operation according to the recorded result. When the locking function has been activated and the sign object has been removed, the cleaning robot is capable of performing the cleaning operation according to the position of the sign object before it was removed.

An exemplary embodiment of a control method for a cleaning robot with a locking function is provided. The control method comprises: detecting and recording a position of a sign object to generate a recorded result; when the locking function has been activated, the cleaning robot performs a cleaning operation according to the recorded result; and when the locking function has been activated and the sign object has been removed, the cleaning robot performs the cleaning operation according to the position of the sign object before it was removed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B show one exemplary embodiment of a cleaning system;

FIGS. 2A and 2B show another exemplary embodiment of a cleaning system;

FIG. 3 shows a flow chart of one exemplary embodiment of a control method; and

FIG. 4 is a flow chart of another exemplary embodiment of a control method.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

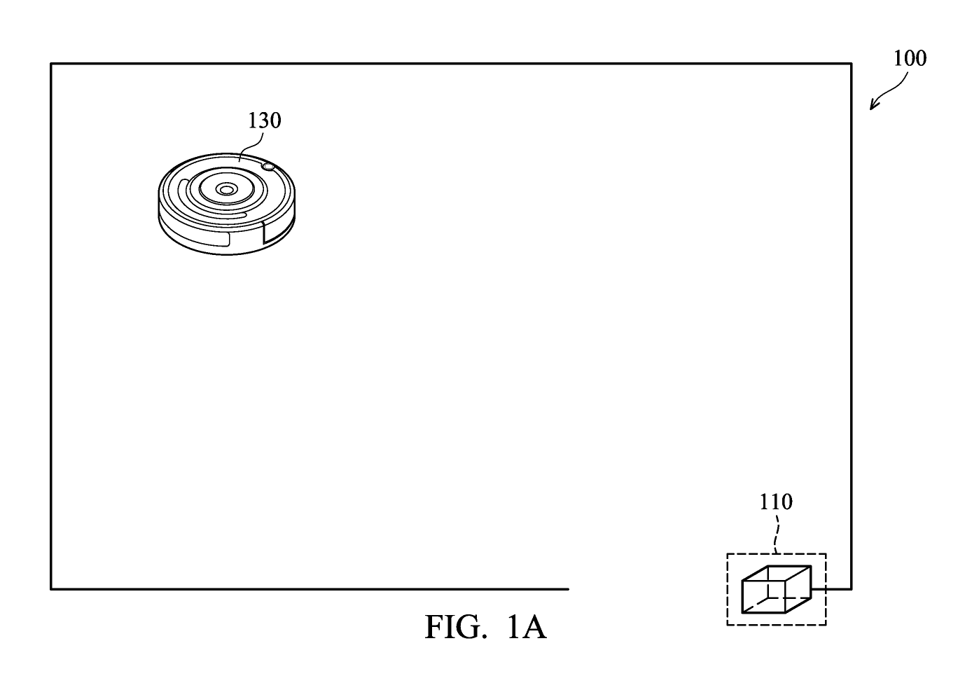

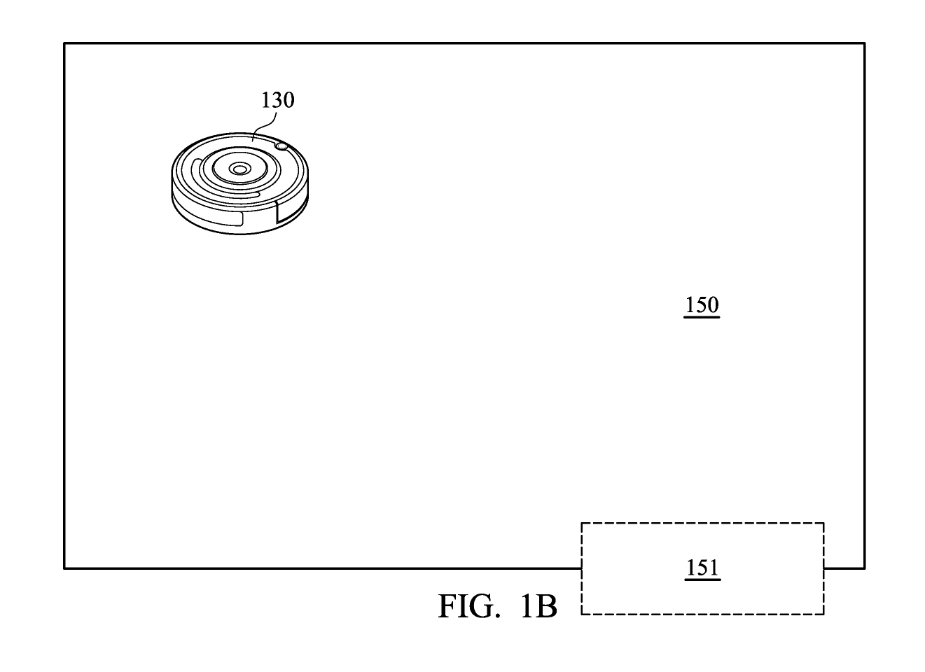

Cleaning systems are provided. In one exemplary embodiment of a cleaning system in FIG. 1A, a cleaning system 100 comprises a sign object 100 and a cleaning robot 130. For a clear description, FIG. 1A shows one single sign object, however, it does not limit the invention. In other embodiments, the number of the sign objects is larger than one. In the embodiment, the sign object is capable of guiding the cleaning robot 130 to a certain area or prohibiting the cleaning robot 130 from entering a certain area. In an embodiment, the sign object 110 is implemented by a virtual wall, such as a light-ray virtual wall, a magnetic stripe virtual wall, or a reflection virtual wall, which has a function of imitating a real wall.

The cleaning robot 130 detects and records the position of the sign object 110 to generate a recorded result. A reflection virtual wall is given as an example. The surface of the reflection virtual wall has a specific pattern, such as a barcode or other patterns. When a light ray illuminates the specific pattern of the reflection virtual wall, reflected light from the surface of the reflection virtual wall is generated. The cleaning robot 130 obtains the position of the sign object 110 according to the reflected light. Thus, in the embodiment, according to the information (such as a light ray, magnetic field, a sound wave, or reflected light) provided from the sign object 110, the cleaning robot 130 knows the existence of the sign object 110 and further obtains the position of the sign object 110.

The invention does not limit how the cleaning robot 130 detects the sign object 110. In an embodiment, the cleaning robot 130 may receive the information provided from the sign object 110 by moving along a wall, moving randomly, moving spirally, or moving in other ways. Then, the cleaning robot 130 detects the received information to obtain the position of the sign object 110.

In an embodiment, when the cleaning robot 130 detects the position of the sign object 110, the cleaning robot 130 records the movement path to generate map information and marks the position of the sign object 110 in the map information. In another embodiment, a user may provide map information to the cleaning robot 130 through a computer apparatus. In this case, the cleaning robot 130 only marks the position of the sign object 110 in the map information provided by the user without building map information by itself.

In the embodiment, the cleaning robot 130 has a locking function. When the locking function has been activated, the cleaning robot 130 can perform the cleaning operation according to the previously recorded result even though the sign object 110 is removed from the original position. For example, when the sign object 110 is removed from an area 151 (shown in FIG. 1B), the cleaning robot 130 can perform the cleaning operation according to the position (the area 151) which the sign object 110 is placed in before the sign object 110 is removed.

The invention does not limit how the locking function is activated. In an embodiment, a user may activate the locking function of the cleaning robot 130 by using a remote controller or pressing a locking button (not shown) of the cleaning robot 130.

In an embodiment, when the locking function has been activated, since the cleaning robot 130 records the position of the sign object, the cleaning robot 130 considers that the sign object 110 is still placed in the area 151 according to the previously recorded results even though the sign object 110 is not placed in the area 151. Thus, the cleaning robot 130 can perform the cleaning operation in the area 150 without passing through the area 151 or entering the area 151 to perform the cleaning operation.

Since the sign object 110 is not fixed in the area 151, the usage convenience is enhanced. For example, if a user does not want the cleaning robot 130 to clean the kitchen, the user places the sign object 110 at the entry of the kitchen once. After the cleaning robot 130 detects and records the position of the sign object 110, the user removes the sign object 110. When the locking function of the cleaning robot 130 has been activated, the cleaning robot 130 starts to clean other areas excluding the kitchen.

Due to the locking function, the user places the sign object 110 at the entry of the kitchen only once and does not require placing the sign object 110 at the entry of the kitchen afterward. The cleaning robot 130 performs the cleaning operation according to the previously recorded results. Thus, the usage convenience is enhanced for the user. Moreover, since the sign object 110 is not placed in a certain area continuously, decoration and appearance of the interior of the house of a user is not affected disadvantageously.

Moreover, if the cleaning area is required to be re-defined, a user can inactivate the locking function. Then, the cleaning robot 130 performs the cleaning operation by moving in a standard way, such as by moving along a wall, moving randomly, or moving spirally, while continuously detecting whether there is a new sign object. In an embodiment, the user can press the locking button again to inactivate the locking function.

In an embodiment, the cleaning robot 130 has an erasing function. When the erasing function has been activated, the previously recorded result of the cleaning robot 130 is erased. In another embodiment, the cleaning robot 130 further has an editing function. When the editing function has been activated, the previously recorded result can be edited, such as, canceling or modifying the recorded position of the sign object or adding a new position of the sign object.

Moreover, the cleaning robot 130 has a determination function. When the determination function has been activated, the cleaning robot 130 starts to determine the position of the sign object to generate a determination result. When the determination result is different from the previous recorded result, the cleaning robot 130 updates the recorded result according to the determination result.

In an embodiment, if the number of sign objects is changed (increased or decreased) or the position of the sign object is changed, the recorded result can be updated through the determination function. For example, a user may not allow the cleaning robot 130 to enter the bedroom and the kitchen. Since the sign object was originally placed at the entry of the kitchen, the user only has to place the sign object at the entry of the bedroom. Thus, even if the user only has one sign object, the cleaning robot 130 can be prohibited from entering two areas: the bedroom and the kitchen

In another embodiment, when the locking function has been activated and the determination function has not been activated, if the position of the sign object 130 is changed and the sign object 130 with the changed position is placed in a specific area (such as the area 150), the cleaning robot 130 regards the sign object as a block.

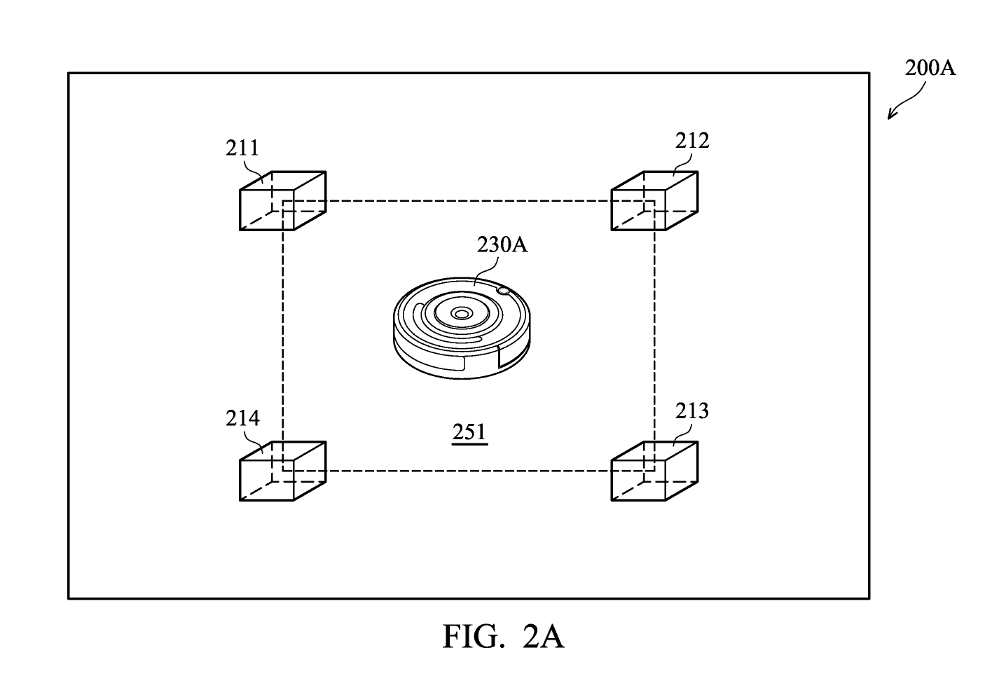

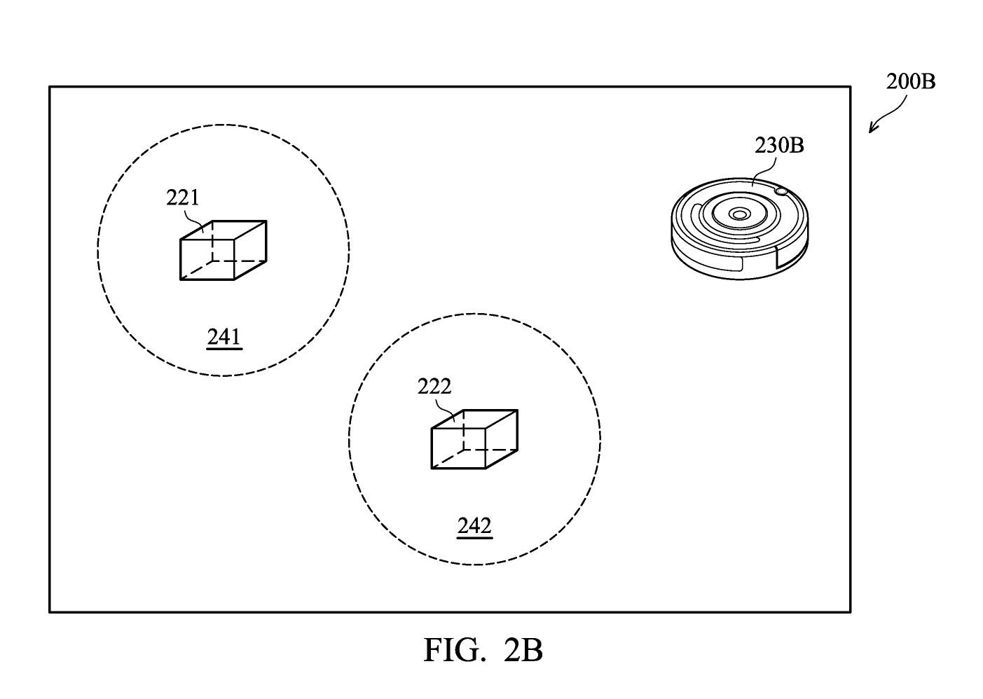

FIG. 2A shows another exemplary embodiment of a cleaning system. In the embodiment, a cleaning system 200A comprises sign objects 211-214. A cleaning robot 230A detects and records positions of the sign objects 211-214. According to the positions of the sign objects 211-214, the cleaning robot 230A defines a specific area 251, which is represented by dotted lines.

When a locking function of the cleaning robot 230A has been activated, the cleaning robots 230A starts to perform a cleaning operation. If the cleaning robot 230A is in the specific area 251, the cleaning robot 230A performs the cleaning operation to the inside of the specific area 251. In contrast, when the cleaning robot 230A is on the outside of the specific area 251, the cleaning robot 230A performs the cleaning operation to the outside of the specific area 251.

Moreover, according to the positions of the sign objects, a point area can be defined. As shown in FIG. 2B, a cleaning robot 230B detects and records positions of sign objects 221 and 222. The cleaning robot 230B defines point areas 241 ad 242 according to the recorded result. Then, when a locking function of the cleaning robot 230B has been activated, the cleaning robot 230B performs a cleaning operation only to the point areas 241 and 242.

The invention does not limit the sequence for which the cleaning robot 230B enters the point areas 241 and 242. In an embodiment, the cleaning robot 230B may enter to the point area, for example the point area 241, closest to the cleaning robot 230B first. After the cleaning operation to the point area 241 is finished, then the cleaning robot 230B may enter another point area, for example the point area 242, closer to the cleaning robot 230B. In another embodiment, the cleaning robot 230B may perform coding operation to the positions of the sign objects 221 and 222 according to the information (such as a light ray, magnetic field, or reflected light) provided from the sign objects 221 and 222. Then, according to the coding result, the cleaning robot 230B performs the cleaning operation to the point areas 241 and 242.

In the embodiment, the point areas 241 and 242 are defined by radiuses of a predetermined distance from the sign objects 221 and 221 which are at the centers of the radiuses, respectively. The invention does not limit the sizes and shapes of the point areas 241 and 242. In the embodiment, the sizes of the point areas 241 and 242 may be equal, and the shapes of the point areas 241 and 242 may be a circular form. In another embodiment, the sizes and shapes of the point areas 241 and 242 may be different.

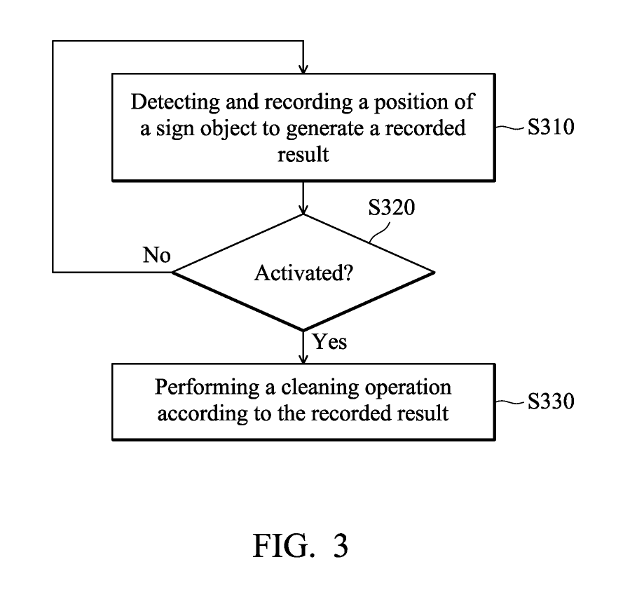

FIG. 3 shows a flow chart of one exemplary embodiment of a control method. The control method is applied to a cleaning robot. First, a position of a sign object is detected and recorded to generate a recorded result (step S310). The invention does not limit the number of sign objects. In an embodiment, the number of sign objects may be greater than two. In another embodiment, the sign object may be a virtual wall.

For example, the sign object is a reflection virtual wall. The surface of the reflection virtual wall has a specific pattern. Thus, when a light ray illuminates the specific pattern, the specific pattern reflects the light ray to generate reflected light from the surface of the reflection virtual wall. The cleaning robot obtains the position of the sign object according to the reflected light.

The invention does not limit how the cleaning robot detects the sign object. In an embodiment, the cleaning robot may receive information provided from the sign object by moving with a predetermined movement way, such as moving along a wall, moving randomly, or moving spirally. Then, the cleaning robot records the position of the sign object according to the received information. When the cleaning robot detects the position of the sign object, the cleaning robot 130 records the movement path to generate map information and marks the position of the sign object in the map information. In another embodiment, the map information may be provided by an external device, such as a computer apparatus.

Then, the cleaning robot determines whether a locking function has been activated (step S320). The invention does not limit how the locking function is activated. In an embodiment, a user may activate the locking function of the cleaning robot by using a remote controller or pressing a locking button of the cleaning robot.

If the locking function has not been activated, the control method proceeds back to the step S310 to detect the position of the sign object continuously. When the locking function has been activated, the cleaning robot performs a cleaning operation according to the recorded result generated in the step S310 (step S330). At this time, when the sign object has been removed, the cleaning robot 130 still can perform the cleaning operation according to the position of the sign object before it was removed.

In an embodiment, the cleaning robot defines a specific area according to the recorded result generated in the step S310. The cleaning robot can perform the cleaning operation to the inside or outside of the specific area. In another embodiment, the specific area is a point area, and the sign object is at the center of the point area. When the locking function has been activated, the cleaning robot performs the cleaning operation in the point area.

In an embodiment, the cleaning robot has a determination function. When the determination function has been activated, the cleaning robot starts to determine the position of the sign object to generate a determination result. When the determination result is different from the previous recorded result, the cleaning robot updates the recorded result according to the determination result. For example, after a user adds a new sign object or modifies or removes the sign object, if the determination function has been activated, the cleaning robot can update the recorded result according to the changed situation.

In an embodiment, when the locking function has been activated and the determination function has not been activated, if the position of the sign object has been changed and the sign object with the changed position is placed in a previously defined specific area, the cleaning robot regards the sign object as a block.

In an embodiment, the cleaning robot has an erasing function. When the erasing function has been activated, the previously recorded result of the cleaning robot is erased. In this case, the cleaning robot detects and records the position of the sign object again.

In another embodiment, the cleaning robot further has an editing function. When the editing function has been activated, the previously recorded result can be edited. For example, a user can edit the previously recorded result by using a computer apparatus or by directly pressing a control button of the cleaning robot.

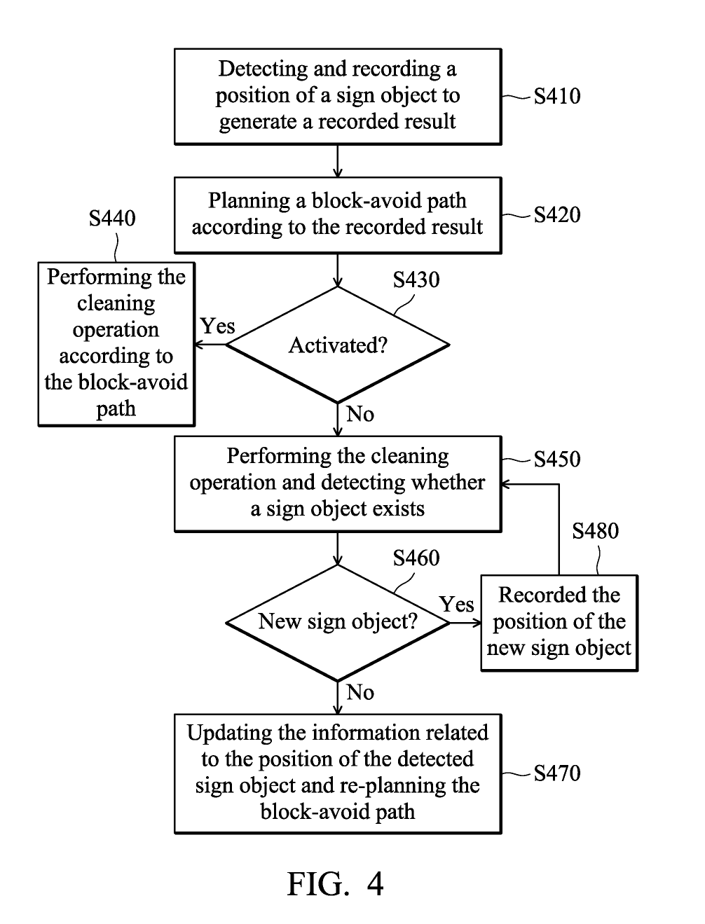

FIG. 4 is a flow chart of another exemplary embodiment of a control method. First, a position of a sign object is detected and recorded to generate a recorded result (step S410). When the position of the sign object is detected, a cleaning robot records the movement path to generate map information. In an embodiment, a user directly or indirectly modifies the recorded result and the map information of the cleaning robot. For example, the user inputs map information to the cleaning robot by a computer apparatus. In the embodiment, the cleaning robot only marks the position of the sign object in the map information.

Then, according to the recorded result, a block-avoid path is planned (step S420). Similarly, a user can directly or indirectly modify the block-avoid path. Then, it is determined whether a locking function has been activated (step S430). If the locking function has been activated, the cleaning robot moves according to the block-avoid path (step S440). At this time, since the cleaning robot recorded the position of the sign object, the cleaning robot can keep away from the area which the sign object is originally placed in even though the sign object is removed.

If the locking function has not been activated, the cleaning robot is controlled to perform the cleaning operation and detect whether a sign object exists (step S450). If a sign object is detected, the cleaning robot determines whether the detected sign object is a new sign object (step S460). If the detected sign object is not a new sign object, when the detected sign object is removed from the original position, the information related to the position of the detected sign object is updated, and the block-avoid path is re-planned (step S470). If the detected sign object is a new sign object, the position of the new sign object is recorded (step S480), and the block-avoid path is re-planned.

As the above describes, when a locking function of a cleaning robot has been activated, the cleaning robot performs a cleaning operation according to a previous recorded result. Since the cleaning robot records a position of a sign object, the cleaning robot keeps away from the area which the sign object is originally placed in even though the sign object is removed.

The sign object is not required to be fixed in a certain area, and a user may place the sign object only once. Thus, decoration and appearance of the interior of the house of the user is not affected disadvantageously. Moreover, when there is only one sign object, many specific areas (the areas requiring cleaning or not) may be defined by repeatedly using the sign object, enhancing usage convenience.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cleaning system comprising:
at least one sign object; and
a cleaning robot for detecting and recording a position of the sign object to generate a recorded result and having a locking function,
wherein when the locking function has been activated, the cleaning robot performs a cleaning operation according to the recorded result, and
wherein when the locking function has been activated and the sign object has been removed, the cleaning robot is capable of performing the cleaning operation according to the position of the sign object before it was removed.

2. The cleaning system as claimed in claim 1, wherein the cleaning robot defines a specific area according to the recorded result.

3. The cleaning system as claimed in claim 2, wherein the cleaning robot performs the cleaning operation in the specific area.

4. The cleaning system as claimed in claim 3, wherein the sign object is at a center of the specific area.

5. The cleaning system as claimed in claim 2, wherein the cleaning robot performs the cleaning operation on an outside of the specific area.

6. The cleaning system as claimed in claim 2,
wherein the cleaning robot has a determination function,
wherein when the determination function has been activated, the cleaning robot starts to determine the position of the sign object to generate a determination result, and
when the determination result is different from the recorded result, the cleaning robot updates the recorded result according to the determination result.

7. The cleaning system as claimed in claim 6, wherein when the locking function has been activated and the determination function has not been activated, if the position of the sign object has been changed and the sign object with the changed position is placed in the specific area, the cleaning robot regards the sign object as a block.

8. The cleaning system as claimed in claim 1, wherein the cleaning robot has an erasing function, and when the erasing function has not been activated, the recorded result is erased.

9. The cleaning system as claimed in claim 1, wherein the cleaning robot has an editing function, and when the editing function has been activated, the recorded result is edited.

10. The cleaning system as claimed in claim 1, wherein a surface of the sign object has a specific pattern, and when a light ray illuminates the specific pattern, reflected light is generated, and the cleaning robot obtains the position of the sign object according to the reflected light.

11. A control method for a cleaning robot with a locking function comprising:
detecting and recording a position of a sign object to generate a recorded result;
when the locking function has been activated, the cleaning robot performing a cleaning operation according to the recorded result; and
when the locking function has been activated and the sign object has been removed, the cleaning robot performing the cleaning operation according to the position of the sign object before it was removed.

12. The control method as claimed in claim 11 further comprising:
defining a specific area according to the recorded result.

13. The control method as claimed in claim 12 further comprising:
controlling the cleaning robot to perform the cleaning operation in the specific area.

14. The control method as claimed in claim 13, wherein the sign object is at a center of the specific area.

15. The control method as claimed in claim 12 further comprising:
controlling the cleaning robot to perform the cleaning operation on an outside of the specific area.

16. The control method as claimed in claim 12, wherein the cleaning robot has a determination function, and the control method comprises:
when the determination function has been activated, the cleaning robot determining the position of the sign object to generate a determination result, and
when the determination result is different from the recorded result, the cleaning robot updating the recorded result according to the determination result.

17. The control method as claimed in claim 16, wherein when the locking function has been activated and the determination function has not been activated, if the position of the sign object has been changed and the sign object with the changed position is placed in the specific area, the cleaning robot regards the sign object as a block.

18. The control method as claimed in claim 11, wherein the cleaning robot has an erasing function, and the control method comprises:
when the erasing function has not been activated, erasing the recorded result.

19. The control method as claimed in claim 11, wherein the cleaning robot has an editing function, and the control method comprises:
when the editing function has been activated, editing the recorded result.

20. The control method as claimed in claim 11, wherein a surface of the sign object has a specific pattern, and when a light ray illuminates the specific pattern, reflected light is generated, and the cleaning robot obtains the position of the sign object according to the reflected light.
